(19) United States
(12) Patent Application Publication
(10) Pub. No.: US 2013/0315746 A1
(43) Pub. Date: Nov. 28, 2013

(54) Wind blades and producing method thereof

(71) Applicants: Zaiman Huang, Beijing (CN); Suo Ding, Beijing (CN); Xingbo Wang, Beijing (CN); Chengliang Li, Beijing (CN); Shiqiang Zhang, Beijing (CN); Jinqian Tang, Beijing (CN)

(72) Inventors: Zaiman Huang, Beijing (CN); Suo Ding, Beijing (CN); Xingbo Wang, Beijing (CN); Chengliang Li, Beijing (CN); Shiqiang Zhang, Beijing (CN); Jinqian Tang, Beijing (CN)

(73) Assignee: Sinomatech Wind Power Blade Co., Ltd.

(21) Appl. No.: 13/481,782

(22) Filed: May 26, 2012

(51) Int. Cl. F03D 1/06; B23P 15/02

(52) U.S. Cl. 416/223 R; 29/889.7

(57) ABSTRACT

A method of producing a pre-bent wind blade, includes: obtaining a pre-bent curve of a straight wind blade; and producing a bent wind blade according to the pre-bent curve, in such a manner that under a rating wind speed, the wind blade extends to be straight, so as to increase energy yield annually.

### BACKGROUND OF THE PRESENT INVENTION

1. Field of Invention

The present invention relates to wind blades, and more particularly to bent wind blades having lower rating wind speed than straight wind blades of same length, and a designing and forming method thereof.

2. Description of Related Arts

Energy source is a common problem all mankind face. The traditional energy source decreases gradually, and thus cannot meet people's need. What is worse, energy sources such as thermal power, oil and natural gas, pollute the environment greatly. Therefore, it is urged to develop new clean energy source. Wind power is a clean source that gains more and more attention from people. Wind is an energy source that has no environmental pollution and is inexhaustible. For islands, pastures, mountains and highlands which lack of water, fuel, and convenient transport, wind power is extremely applicable according to local conditions.

Wind power is converting the kinetic energy of wind into mechanical kinetic energy, and then converting the mechanical kinetic energy into electric kinetic energy. The mechanism of wind power is that wind drives blades of a wind driven generator, and then a rotating speed is increased via a speed-enhancing machine to drive a generator. According to the existing technology of wind driven generators, a slight wind of 3 m/s is enough for generating electricity. Wind power has become an upsurge all over the world, since wind power does not need fuel, produce radiation or pollute the environment.

The device that the wind power needs is called wind driven generator, or wind generator for short, as shown in FIG. 1. The wind generator comprises a wind rotor, a nacelle and a tower frame.

The wind rotor is an important component for converting the kinetic energy of wind into mechanical kinetic energy, and ordinarily consists of three blades. When wind is blowing on the blades, a wind force drives the wind rotor to rotate. The material of the blades has the requirements of high intensity and low weight, and mainly adopts glass fiber reinforced plastics or other composite materials such as carbon fibers.

The electric generator and relative devices are positioned inside the nacelle which is on the top of the wind generator and is nacelle cabin for having a similar shape as the nacelle in ships or aircraft.

The tower frame is a frame for supporting the wind rotor and the electric generator. It is ordinarily built tall for obtaining strong and even wind force, and having enough intensity. The tallness is determined by the affection of ground barriers to wind speed and the diameter of the wind rotor, ordinarily, 6˜150 m.

A key component of the wind generator is the blades. The conventional blades are ordinarily made into straight line, and for catching the wind energy sufficiently, the length of the blades are made long. The larger the rating wind speed is desired, the longer the blades should be. However, in particular wind filed, the wind speed is changing. When the wind speed reaches to a certain value, the straight-lined blades bend to deform. Accordingly, the swept diameter of the straight-lined blades decreases, and the utilizing rate of wind energy of the wind generator decreases. How to utilizing the wind energy under rating wind speed to the extend? As so far, the straight blades can not solve the problem.

### SUMMARY OF THE PRESENT INVENTION

An object of the present invention is to provide a bent wind blade, which has lower rating wind speed than a straight blade of same length.

Another object of the present invention is to provide a method of designing the above bent wind blade.

Accordingly, in order to accomplish the above objects, the present invention provides a method of designing a bent wind blade, comprising:
designing a straight blade for being applied a load of a main range of wind speed;
removing the load;
calculating by simulation to obtain a corresponding deforming value;
obtaining a pre-bent curve according to the deforming value;
designing the bent wind blade according to the pre-bent curve; and
molding the bent wind blade according to the designing.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a wind generator according to a preferred embodiment of the present invention.

FIG. 2 is a perspective view of the wind generator according to the preferred embodiment of the present invention, illustrating a swept area of a wind rotor.

FIG. 3 is a sketch view of a straight wind blade according to a preferred embodiment of the present invention, which is bent under the wind force.

FIG. 4 is a sketch view of a bent wind blade according to a preferred embodiment of the present invention, which is deformed to be straight under the wind force.

FIG. 5 is a schematic diagram of a relationship between the swept area of the wind rotor and a power rating.

FIG. 6 is a schematic diagram of analyzing the maximum swept area of the wind rotor.

FIG. 7 is a schematic diagram of a wind blade which is straight under a wind load.

FIG. 8 is a schematic diagram of the wind blade of FIG. 7 removing the wind load.

FIG. 9 is a pre-bent curve of the bent wind blade.

FIG. 10A is a platform view of the bent wind blade according to the preferred embodiment of the present invention.

FIG. 10B is a front view of the bent wind blade according to the preferred embodiment of the present invention.

FIG. 11 is a schematic diagram of a comparison of power between the bent wind blade according to the present invention and a straight wind blade according to prior art.

FIG. 12 is a bending moment curve of the example wind blade under rating wind speed.

FIG. 13 is a deflection curve of the example wind blade under rating wind speed.

FIG. 14 is a sketch view of the wind blades under rating wind speed.

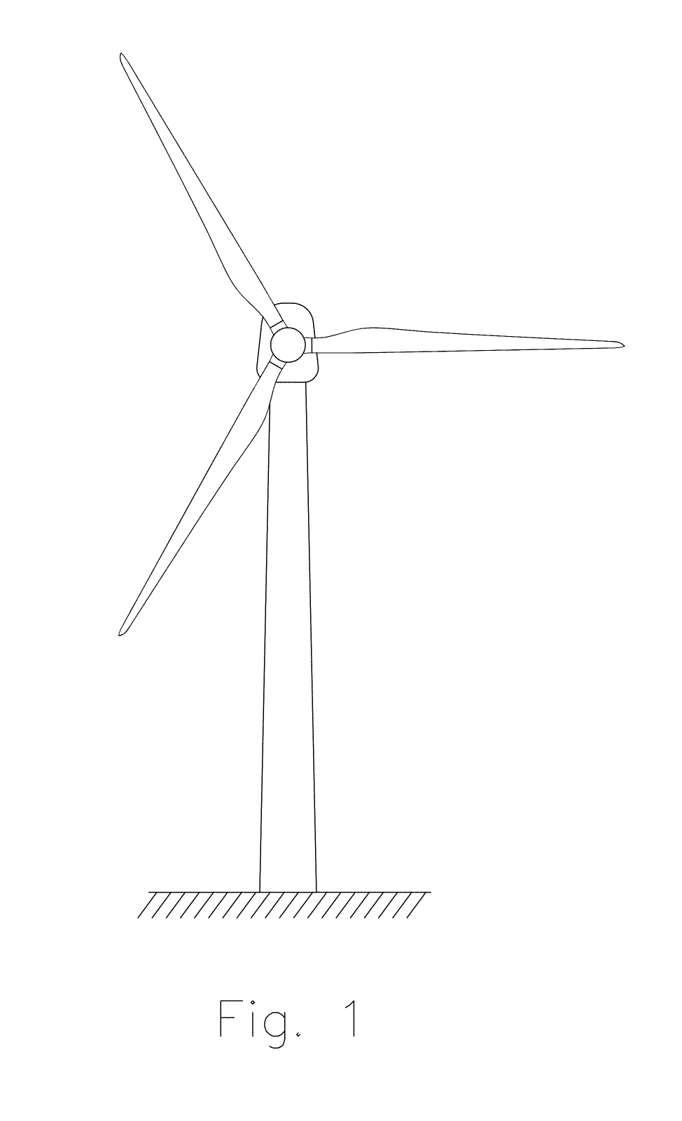

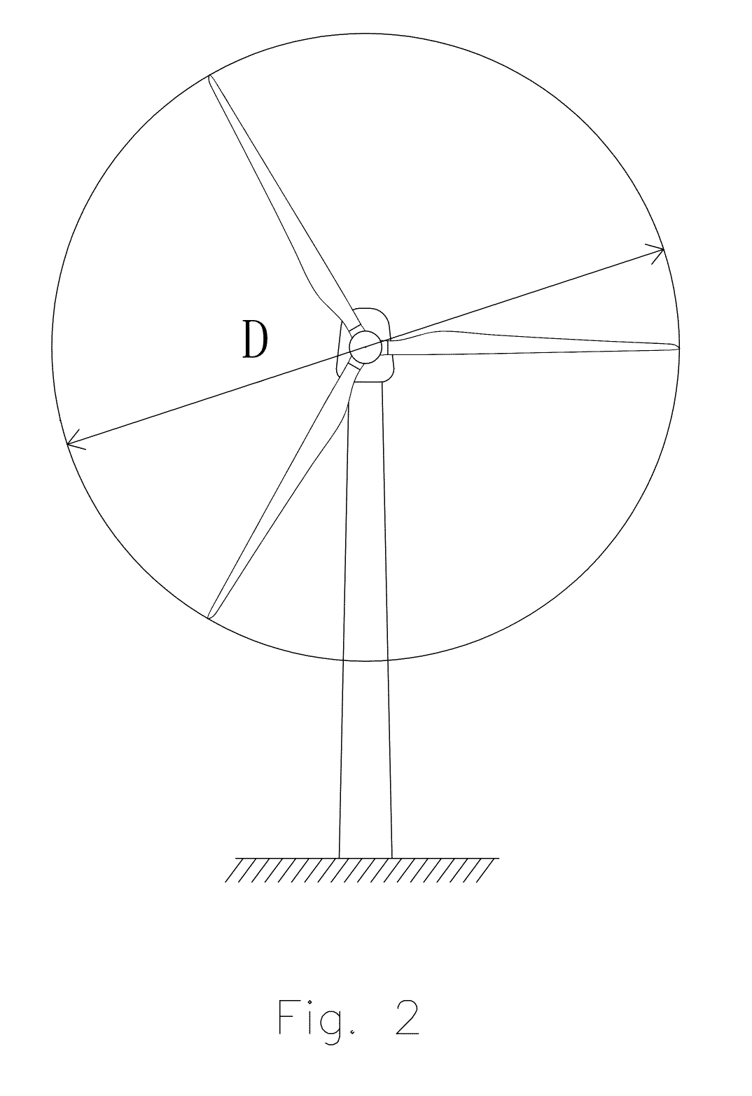

1—conventional wind blade
2—rating wind speed (Vr)
3—bent wind blade according to the present invention
4—straight wind blade
5—simulated wind load (Vr′)
6—pre-bent curve

### DETAILED DESCRIPTION OF THE PREFERRED EMBODIMENT

An output power of electric generating of a wind generator is:

$$p = \frac{1}{2} ρ {v}_{r}^{3} {C}_{p} A$$

wherein,
p is the output power of the wind generator;
ρ is air density;
Vr is a rating wind speed of the wind generator; and
A is a swept area of a wind rotor.

It is shown that, with a certain output power, the bigger the swept area of the wind rotor is, the smaller the rating wind speed needed is. The swept area is relative to a diameter D that the wind rotor of the wind generator sweeps. Therefore, to reduce the rating wind speed, the diameter D that the wind rotor of the wind generator sweeps should be increased.

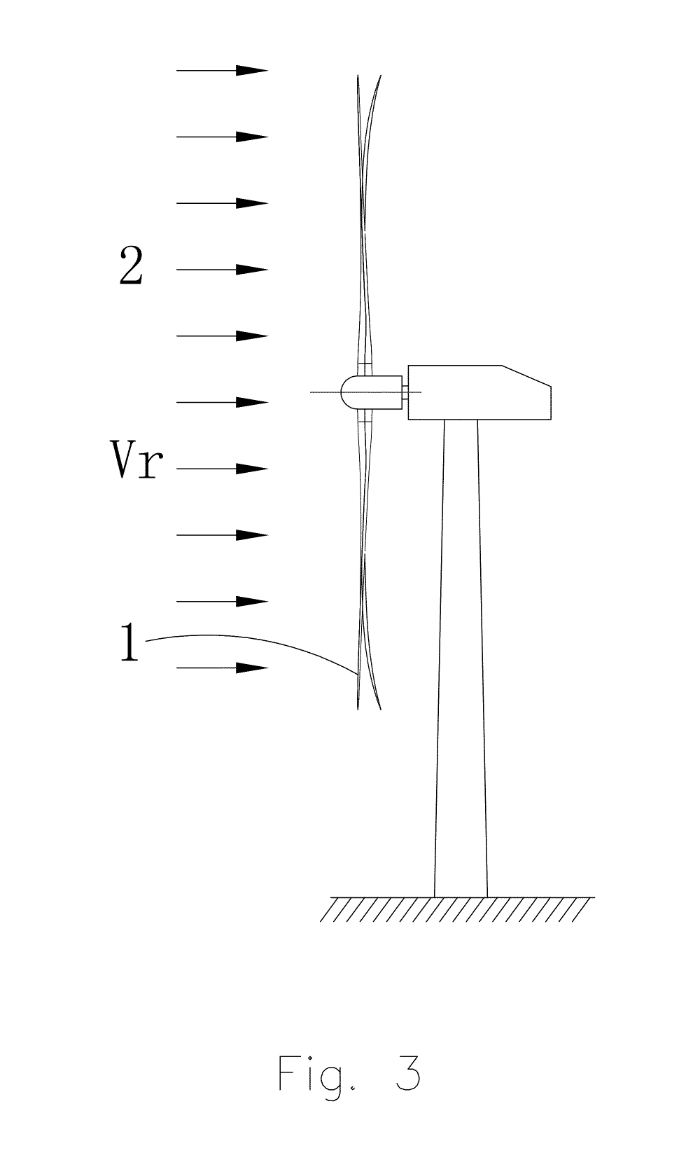

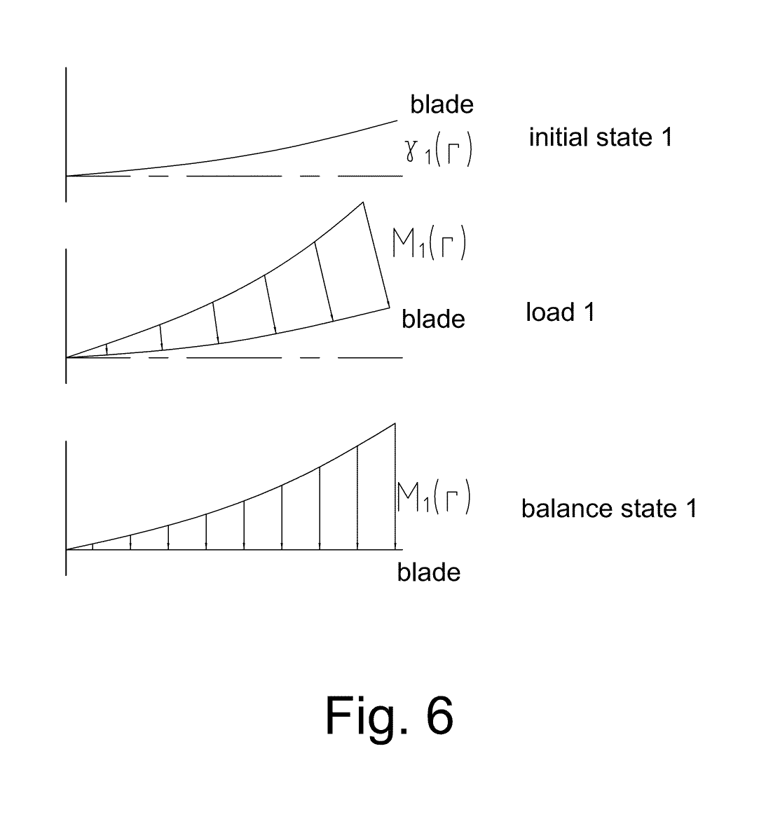

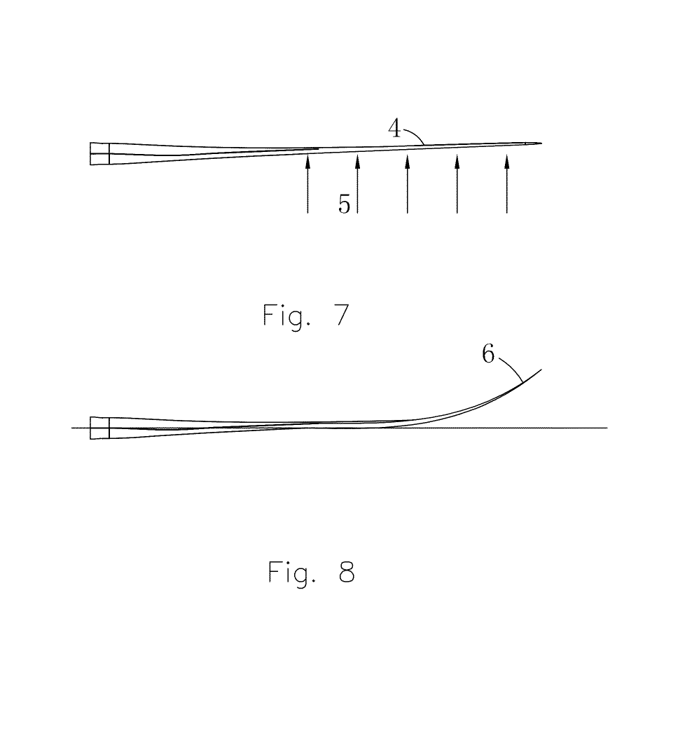

When the wind of any speed blows to a blade, a corresponding load is applied to the blade. And the blade deforms correspondingly after being applied with the load. In the same area, the load applied to the blade increases, and the deformation of the blade increases, as the wind speed increases. A straight blade 1 is ordinarily design to be straight line shaped, and deforms when being applied with a wind load, as shown in FIG. 3. The deformed blade has a smaller swept diameter to reduce the output power of the wind generator. To ensure a maximum swept area of the wind generator under the rating wind speed, (i.e., the blade is in a straight manner under the rating wind speed, as a M₁(r) balance manner 1 shown in FIG. 6), an original manner 1 in FIG. 6 should be an original manner of the blade.

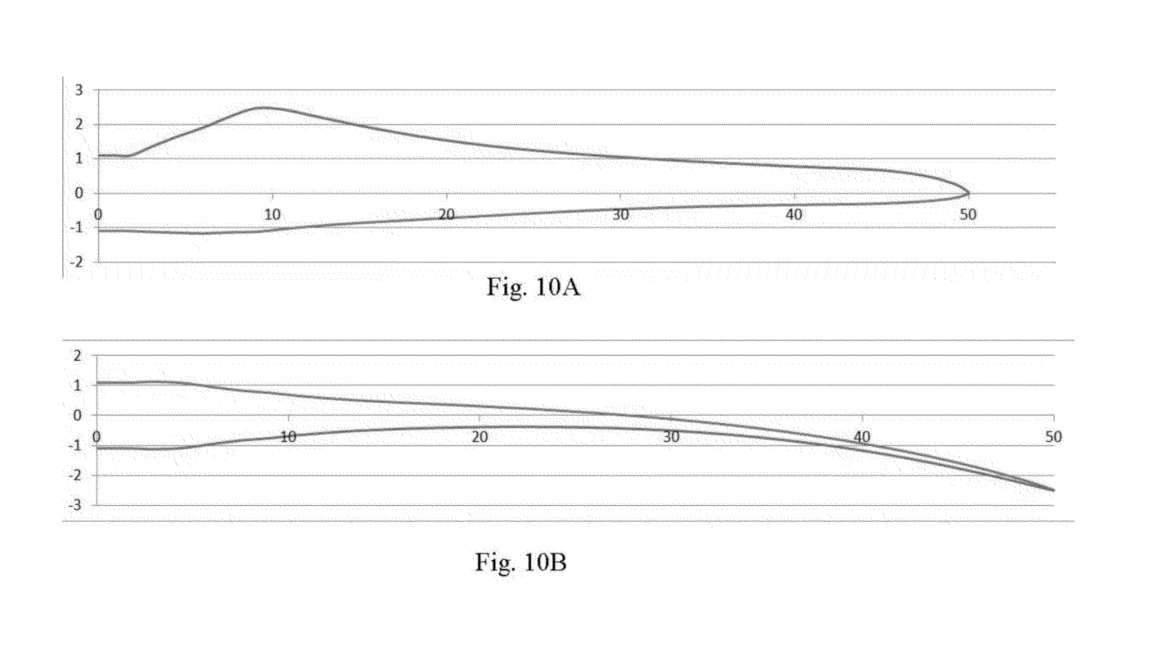

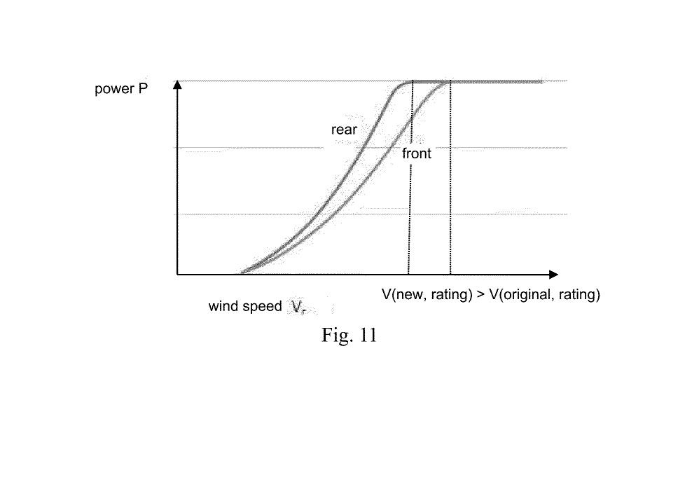

Accordingly, the present invention provides a method of forming a bent wind blade which has lower rating wind speed and higher utilizing rate of wind energy than a straight wind blade having same length, comprises:
first, in a designing stage, simulatedly applying a load of a main range of wind speed to a straight wind blade;
second, removing the load, so that the wind blade recovers from bending, and calculating by equal simulation;
third, calculating by simulation to obtain a corresponding deforming value of the wind blade;
fourth, obtaining a pre-bent curve according to the deforming value;
fifth, in particular producing, molding the bent wind blade 3 according to the pre-bent curve, as shown in FIG. 10.

The detailed algorithm is as follows.

### 1. Calculating Mechanism

A bent deforming curve of a cantilever has a relationship with the load and rigidity:

EI_{z}(r)·γ″(r)=−M_{z}(r) (1)

wherein
r is a diameter of blade;
EI_{z}(r) is a rigidity of the pre-bent direction of the blade;
γ(r) is a deformation shift of the blade;
M_{z}(r) is a sectional bending moment of the pre-bent direction of the blade;
   the above equation considers only pure bending of the cantilever without shearing deformation.

The equation (1) is integrated to obtain:

$$γ ( r ) = - \int {\int }_{r} \frac{{M}_{z} ( r )}{{EI}_{z} ( r )} \cdot d r \qquad ( 2 )$$

### 2. Calculating Steps

### 2.1 Calculating of the Sectional Bending Moment of the Pre-Bent Direction of the Blade M_{z}(r).

The blade takes multiple and complicated wind load in particular use. For ensuring the bending deforming curve fo the blade, representative wind load must be input as the original load for the pre-bent designing blade. The original load becomes a typical load. In the present calculating, the load of main range of wind speed is used as typical load.

According to the bending moment applying to different sections of the blade under main range of wind speed, a bending moment curve M_{z}(r) is fit.

### 2.2 Calculating of Rigidity of Blade EI_{z}(r)

The sectional rigidity of blade is ordinarily nonlinear along a radius direction of the blade. The present invention adopts multi-section polynomial fitting, and provides a continuous distribution function along the radius direction of the blade.

### 2.3 Calculating of Deflection Curve of Blade γ(r)

After obtaining the M_{z}(r) and EI_{z}(r) curve, according to the equation (2), obtaining the pre-bent curve of the blade.

### 2.4 Examples

The reference numbers of following calculating examples are from a certain blade with length about 50 m of vacuum molding and glass fiber/epoxy material system.

### 2.4.1 Parameters of the Blade

Length of the blade: the pre-bent blade has a length of 50.5 m, and a projected length of 50 m.

### 2.4.2 Calculating

(1) M(r)

In the present calculating, the load of the blade under a rating wind speed (Vr=9.8 m/s) is used as the typical load.

The bending moment curve after integrating is following.

M(r)=6.861x̂3+8.130e2x̂2−1.260e5x+3.420 e6

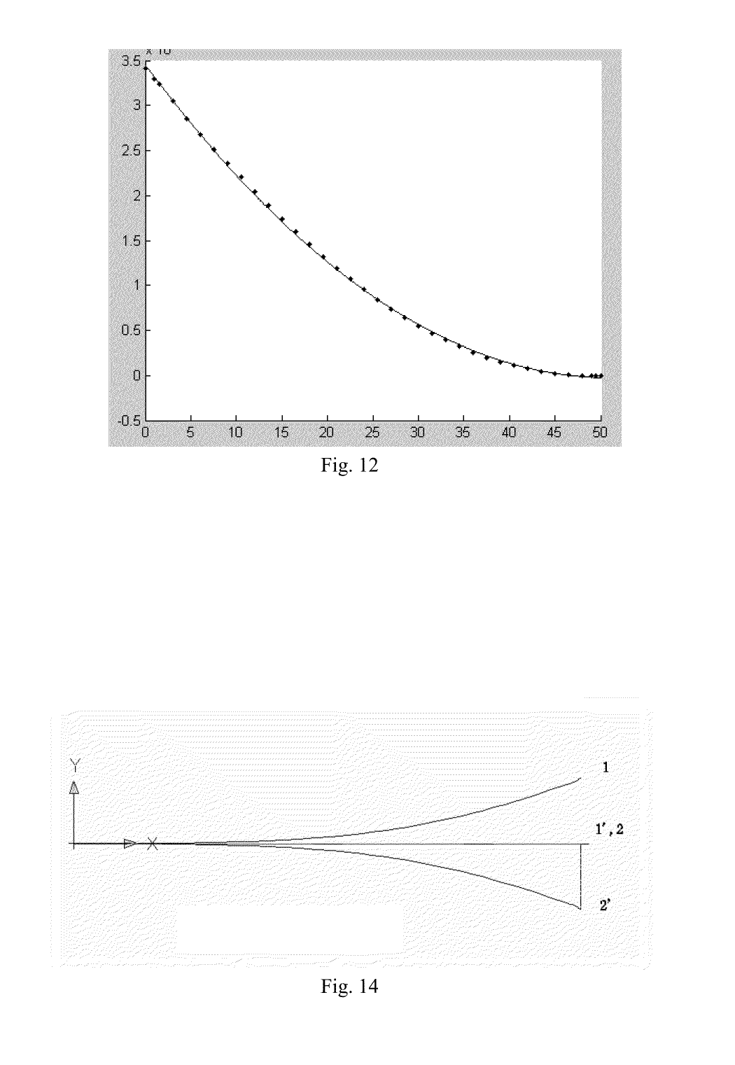

The curve is shown in FIG. 12.

(2) EI(r)

The distribution function of the rigidity of the pre-bent direction of the blade after fitting is following.

$$\{ \begin{matrix}{EI}_{z} ( r ) = 3 e 9 \cdot {r}^{2} - 1 e 10 \cdot r + 1 e 10 & 0 m \leq r \leq 1.5 m \\ {EI}_{z} ( r ) = - 2 e 7 \cdot {r}^{3} + 2 e 8 \cdot {r}^{2} - 1 e 9 \cdot r + 5 e 9 & 1.5 m < r \leq 7.5 m \\ \begin{matrix}{EI}_{z} ( r ) = - 7.94 \cdot {r}^{8} + 1.265 e 3 \cdot {r}^{7} - 8.635 e 4 \cdot {r}^{6} + 3.288 e 6 \cdot {r}^{5} - 7.6104 e 7 \cdot {r}^{4} + \\ 1.0915 e 9 \cdot {r}^{3} - 9.399 e 9 \cdot {r}^{2} + 4.377 e 10 \cdot r - 1.1874 e 9\end{matrix} & 7.5 m < r \leq 30 m \\ \begin{matrix}{EI}_{z} ( r ) = 1.347 \cdot {r}^{6} - 3.2055 e 2 \cdot {r}^{5} + 3.182 e 4 \cdot {r}^{4} - 1.692 e 6 \cdot \\ {r}^{3} + 5.118 e 7 \cdot {r}^{2} - 8.433 e 8 \cdot r + 6.012 e 9\end{matrix} & 30 m < r \leq 49.5 m \\ {EI}_{z} ( r ) = - 3.373 e 4 \cdot r + 1.687 e 6 & 49.5 m < r \leq 50.2 m\end{matrix} \} \qquad ( 3 ) {V}_{o} ( r )$$

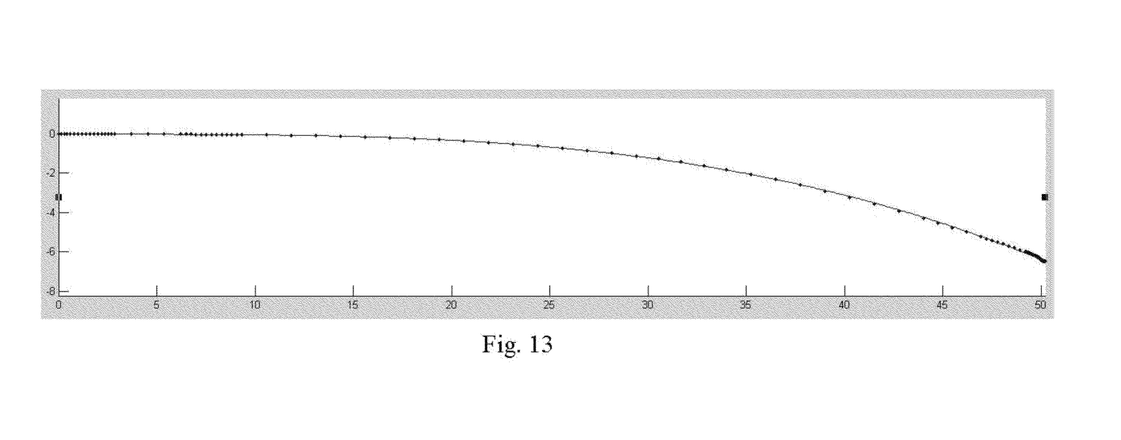

Using the original condition γ(r)=0, and realizing by coding in Matlab, the function of the deflection curve of the blade, γ(r), as shown in FIG. 13, is following.

γ=4.12e−08x5−4.61e−06x4+1.12e−4x3−1.87e−3x2+6.45e−3x−5.17e−3 (5)

### 2.5 Comparison Between the Pre-Bent Blade and the Straight Blade Having Same Length

(1) As shown in FIG. 14, under the rating wind speed, the pre-bent blade deforms from 1 to 2, and an effective length thereof is 51 m, and the straight blade deforms from 1′ to 2′, and an effective length thereof is 50.2 m. According to the equation P=0.5 ρ vr̂3CpA, when P is equal, Vr of straight blade is 9.8 m/s, Vr of bent blade is 9.697 m/s. The rating wind speed is reduced obviously. When the wind speed is equal, (P of straight blade)/(Vr of bent blade)=103.2%, i.e., the power increases by 3.2%.

(2) According to experiences, assuming that a main shaft has a length of 2.5 m, and a price of 200,000 yuan. With respect to the states of 2 and 2′, the pre-bent blade can also reduce the length of the main shaft relatively, so as to reduce cost.

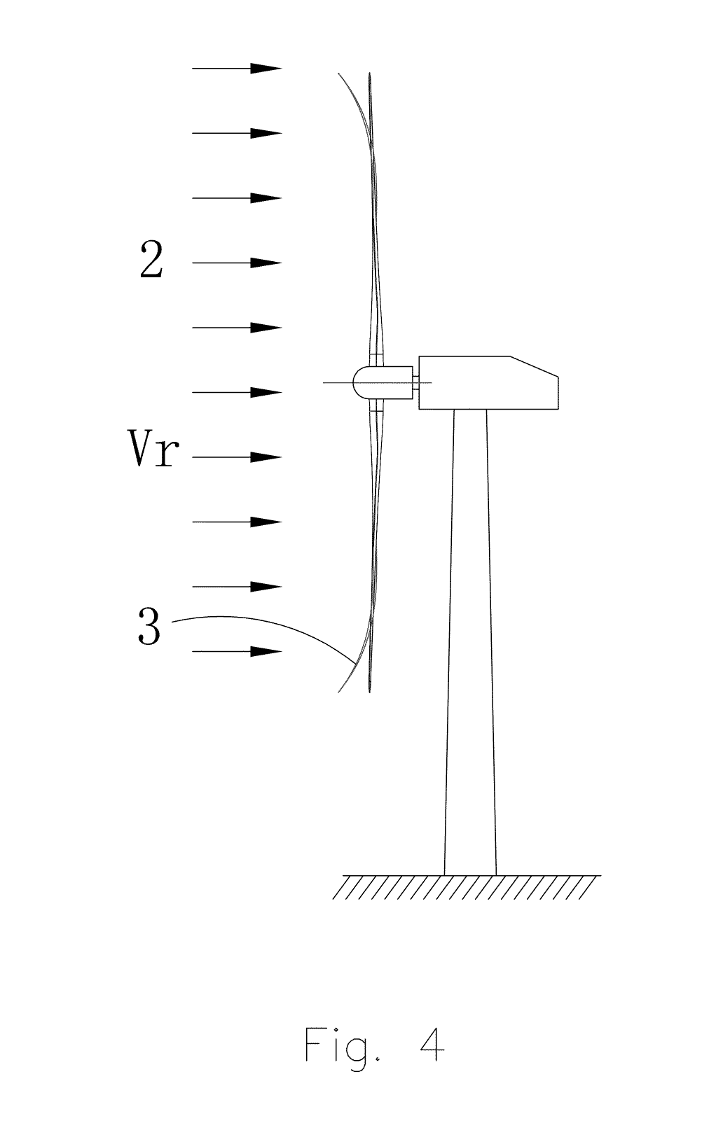

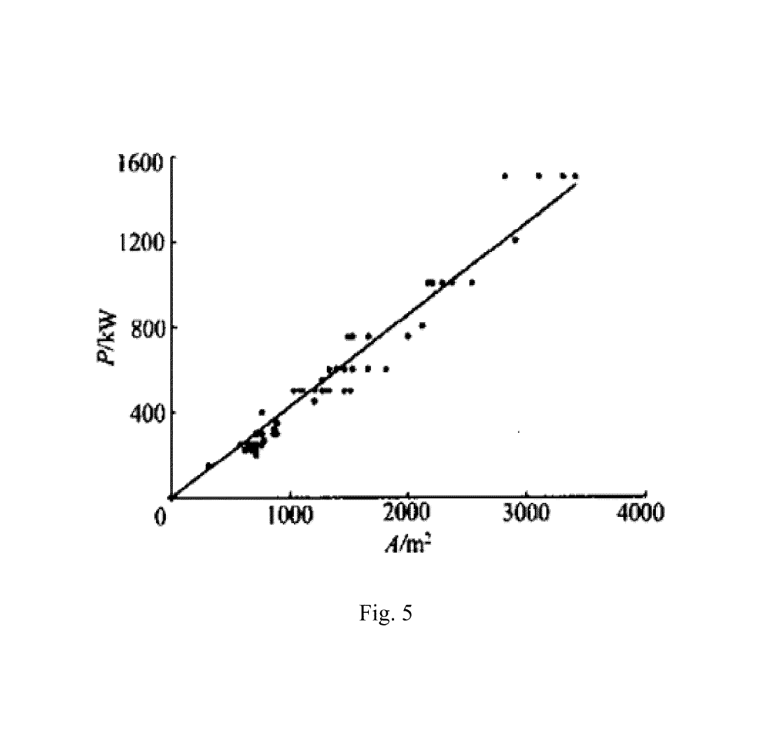

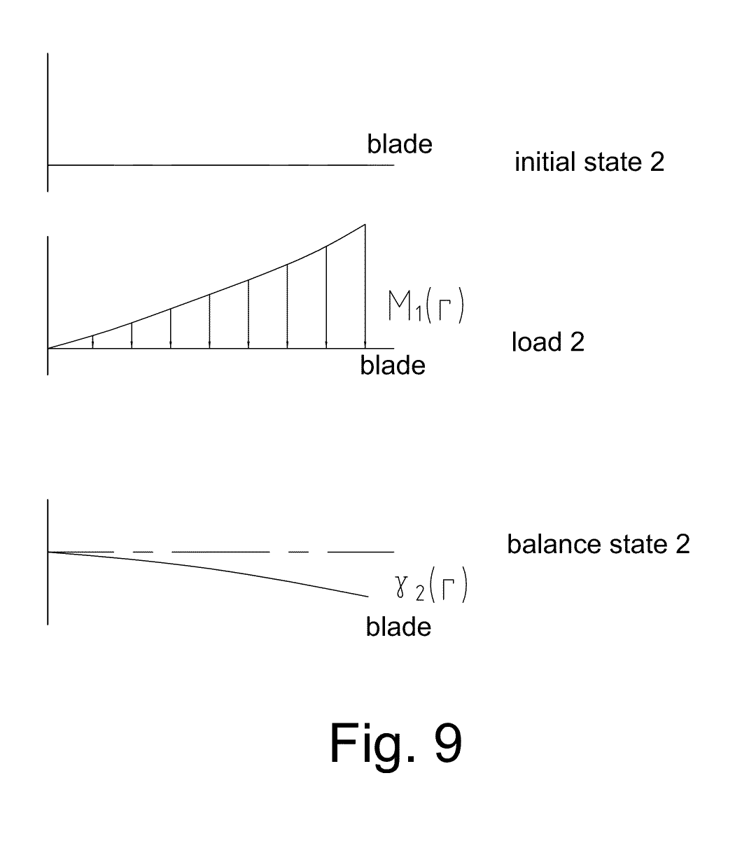

The blade designed and shaped according to the above method, can reach to the rating power earlier than the straight blade having same length, so as to utilize the wind energy more efficiently than the straight blade under same conditions. In particular wind filed, the bent blade works as follows. Under rating wind speed, the blade according to the present invention produces corresponding deformation. Since the blade is pre-bent according to the corresponding load of the rating wind speed in production, the blade according to the present invention extends to straight line from the original bent state, as shown in FIGS. 4 and 9. Therefore, the swept diameter of the blade reaches to maximum, and the swept area of the blade increases along with the swept diameter. Accordingly, the wind generator reaches to the rating power under a smaller wind speed, i.e., the rating wind speed is reduced, so as to increase the utilizing rate of wind energy.

As compared with the straight blade having same length, the blade 3 according to the present invention has the advantage of increasing the swept area of main rage of wind speed to reach the rating power under lower wind speed, and further advantage of increasing a distance between the blade and a tower frame for preventing the blade from hitting on the tower frame, decreasing a length of a main driving axle to reduce host load, decreasing a weight of the blade to reduce inertial load of the blade, decreasing materials to reduce cost, and so on.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wind blade, wherein said wind blade is pre-bent, in such a manner that under a rating wind speed, said wind blade extends to be straight, so as to increase an utilizing rate of wind energy.

2. The wind blade, as recited in claim 1, wherein said wind blade is a Sinoma 50.2 blade.

3. A method of producing a pre-bent wind blade, comprising:
obtaining a pre-bent curve of a straight wind blade; and
producing a bent wind blade according to the pre-bent curve, in such a manner that under a rating wind speed, the wind blade extends to be straight, so as to increase an utilizing rate of wind energy.

4. The method, as recited in claim 3, wherein obtaining a pre-bent curve of a straight wind blade comprises:
simulatedly applying a load of a main range of wind speed to the straight wind blade;
removing the load, so that the straight wind blade recovers from bending;
calculating by simulation to obtain a corresponding deforming value of the straight wind blade; and
obtaining the pre-bent curve according to the deforming value.

5. The method, as recited in claim 4, wherein the pre-bent curve is calculated with the following equation.
$$γ ( r ) = - \int {\int }_{r} \frac{{M}_{z} ( r )}{{EI}_{z} ( r )} \cdot d r$$
wherein
r is a diameter of the straight wind blade;
EI_{z}(r) is a rigidity of a pre-bent direction of the straight wind blade;
γ(r) is a deformation shift of the straight wind blade; and
M_{z}(r) is a sectional bending moment of the pre-bent direction of the straight wind blade.
